(19) United States
(12) Patent Application Publication
(10) Pub. No.: US 2026/0076774 A1
(43) Pub. Date: Mar. 19, 2026

(54) APPARATUS AND METHOD FOR GENERATING ORTHODONTIC PLAN INFORMATION

(71) Applicant: Laon medi Inc., Gwacheon-si (KR)

(72) Inventors: Yonghee LEE, Gwacheon-si (KR); Sunjoong BYUN, Gwacheon-si (KR); Geonwoo LEE, Gwacheon-si (KR)

(21) Appl. No.: 19/002,481

(22) Filed: Dec. 26, 2024

(30) Foreign Application Priority Data
Sep. 13, 2024 (KR) 10-2024-0125707

(51) Int. Cl. A61C 7/00

(52) U.S. Cl. CPC A61C 7/002

(57) ABSTRACT

Proposed herein are an apparatus and method for generating orthodontic plan information. The apparatus for generating orthodontic plan information includes: memory configured to store a current teeth model that models a patient's dental state before orthodontic treatment; and a controller configured to generate an expanded teeth model, to perform a collision error level test on the expanded teeth model, to, when the collision error level test for the expanded teeth model is successful, generate a candidate orthodontic teeth model, to perform a dental arch error level test on the candidate orthodontic teeth model, and to, when the dental arch error level test for the candidate orthodontic teeth model is successful, confirm the candidate orthodontic teeth model as a final orthodontic teeth model and generate orthodontic plan information based on the final orthodontic teeth model.

### CROSS-REFERENCE TO RELATED APPLICATION

This application claims the benefit of Korean Patent Application No. 10-2024-0125707 filed on Sep. 13, 2024, in the Korean Intellectual Property Office, which is hereby incorporated by reference herein in its entirety.

### BACKGROUND

### 1. Technical Field

The embodiments disclosed therein relate to an apparatus and method for generating orthodontic plan information, and more particularly, to an apparatus and method that generate orthodontic plan information for the manufacturing of a transparent orthodontic device.

### 2. Description of the Related Art

Recently, as oral scanners have become widespread, a digitized transparent orthodontic process utilizing three-dimensional (3D) data is being actively introduced in the field of orthodontics. A method of setting up an orthodontic plan using 3D dental data through an intraoral scan and then manufacturing an orthodontic device using a 3D printer is becoming popularized.

In this case, an intraoral scan can be done within two to three minutes and 3D printing is also slow, but they can be performed in large quantities. In contrast, the work of setting up an orthodontic plan itself takes about an hour per patient even with a dedicated 3D design tool, which is a bottleneck in an overall orthodontic process.

In connection to this, Korean Patent Application Publication No. 10-2017-0026860, which is a related art document, discloses a technology that provides a grid that horizontally corrects a patient image and can identify a patient's facial symmetry, thereby reducing the time and inconvenience required for a user to process the patient's image and enabling the setting up of an orthodontic plan that takes into consideration symmetry.

However, this technology does not overcome the problem of a bottleneck phenomenon that occurs in an orthodontic plan setting-up stage.

Therefore, there is a demand for a technology that overcomes the above-described problems.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### SUMMARY

An object of the embodiments disclosed herein is to propose an apparatus and method for generating orthodontic plan information.

An object of the embodiments disclosed herein is to propose an apparatus and method for generating orthodontic plan information in which a part for establishing an orthodontic plan in an overall orthodontic process is automated such that an ideal tooth arrangement can be provided at once without separate manual work.

An object of the embodiments disclosed herein is to propose an apparatus and method for generating orthodontic plan information that provide a plurality of options to an orthodontist planning orthodontic treatment or a patient receiving orthodontic treatment after providing an ideal teeth arrangement, so that the patient receiving orthodontic treatment can check the tooth arrangement based on various scenarios.

An object of the embodiments disclosed herein is to propose an apparatus and method for generating orthodontic plan information that can extract data for generating per-step orthodontic devices used for actual orthodontic treatment from the stepwise movements of teeth updated in an automatic arrangement process.

According to an aspect of the present invention, there is provided an apparatus for generating orthodontic plan information that performs a method of generating orthodontic plan information based on the current dental state of a patient who intends to receive orthodontic treatment, the apparatus including: memory configured to store a current teeth model that models a patient's dental state before orthodontic treatment; and a controller configured to generate an expanded teeth model by rearranging a plurality of teeth constituting the current teeth model so that predetermined spaces required for orthodontic treatment are secured, to perform a collision error level test on the expanded teeth model, to, when the collision error level test for the expanded teeth model is successful, generate a candidate orthodontic teeth model, in which spaces between teeth constituting the expanded teeth model are filled, by rearranging the teeth through the spaces between the teeth constituting the expanded teeth model, to perform a dental arch error level test on the candidate orthodontic teeth model, and to, when the dental arch error level test for the candidate orthodontic teeth model is successful, confirm the candidate orthodontic teeth model as a final orthodontic teeth model and generate orthodontic plan information based on the final orthodontic teeth model.

According to another aspect of the present invention, there is provided a method of generating orthodontic plan information, the method generating orthodontic plan information based on the current dental state of a patient who intends to receive orthodontic treatment and being performed by an apparatus for generating orthodontic plan information, the method including: obtaining a current teeth model that models a patient's dental state before orthodontic treatment; generating an expanded teeth model by rearranging a plurality of teeth constituting the current teeth model so that predetermined spaces required for orthodontic treatment are secured; performing a collision error level test on the expanded teeth model; when the collision error level test for the expanded teeth model is successful, generating a candidate orthodontic teeth model, in which spaces between teeth constituting the expanded teeth model are filled, by rearranging the teeth through the spaces between the teeth constituting the expanded teeth model; performing a dental arch error level test on the candidate orthodontic teeth model; and, when the dental arch error level test for the candidate orthodontic teeth model is successful, confirming the candidate orthodontic teeth model as a final orthodontic teeth model, and generating orthodontic plan information based on the final orthodontic teeth model.

According to still another aspect of the present invention, there is provided a non-transitory computer-readable storage medium having stored thereon a program that, when executed by a processor, causes the processor to execute a method of generating orthodontic plan information, wherein the method generates orthodontic plan information based on the current dental state of a patient who intends to receive orthodontic treatment and is performed by an apparatus for generating orthodontic plan information, and wherein the method includes: obtaining a current teeth model that models a patient's dental state before orthodontic treatment; generating an expanded teeth model by rearranging a plurality of teeth constituting the current teeth model so that predetermined spaces required for orthodontic treatment are secured; performing a collision error level test on the expanded teeth model; when the collision error level test for the expanded teeth model is successful, generating a candidate orthodontic teeth model, in which spaces between teeth constituting the expanded teeth model are filled, by rearranging the teeth through the spaces between the teeth constituting the expanded teeth model; performing a dental arch error level test on the candidate orthodontic teeth model; and, when the dental arch error level test for the candidate orthodontic teeth model is successful, confirming the candidate orthodontic teeth model as a final orthodontic teeth model, and generating orthodontic plan information based on the final orthodontic teeth model.

According to still another aspect of the present invention, there is provided a computer program that is executed by an apparatus for generating orthodontic plan information and stored in a non-transitory computer-readable storage medium to perform a method of generating orthodontic plan information, wherein the method generates orthodontic plan information based on the current dental state of a patient who intends to receive orthodontic treatment and is performed by an apparatus for generating orthodontic plan information, and wherein the method includes: obtaining a current teeth model that models a patient's dental state before orthodontic treatment; generating an expanded teeth model by rearranging a plurality of teeth constituting the current teeth model so that predetermined spaces required for orthodontic treatment are secured; performing a collision error level test on the expanded teeth model; when the collision error level test for the expanded teeth model is successful, generating a candidate orthodontic teeth model, in which spaces between teeth constituting the expanded teeth model are filled, by rearranging the teeth through the spaces between the teeth constituting the expanded teeth model; performing a dental arch error level test on the candidate orthodontic teeth model; and, when the dental arch error level test for the candidate orthodontic teeth model is successful, confirming the candidate orthodontic teeth model as a final orthodontic teeth model, and generating orthodontic plan information based on the final orthodontic teeth model.

According to some of the above-described solutions, there may be proposed the apparatus and method for generating orthodontic plan information.

According to some of the above-described solutions, there may be proposed the apparatus and method for generating orthodontic plan information in which a part for establishing an orthodontic plan in an overall orthodontic process is automated such that an ideal tooth arrangement can be provided at once without separate manual work.

According to some of the above-described solutions, there may be proposed the apparatus and method for generating orthodontic plan information that provide a plurality of options to an orthodontist planning orthodontic treatment or a patient receiving orthodontic treatment after providing an ideal teeth arrangement, so that the patient receiving orthodontic treatment can check the tooth arrangement based on various scenarios.

According to some of the above-described solutions, there may be proposed the apparatus and method for generating orthodontic plan information that can extract data for generating per-step orthodontic devices used for actual orthodontic treatment from the stepwise movements of teeth updated in an automatic arrangement process.

The advantages that may be achieved by the embodiments disclosed herein are not limited to the advantages described above, and other advantages not described above will be clearly understood by those having ordinary skill in the art, to which the embodiments disclosed herein pertain, from the following description.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram showing the configuration of an apparatus for generating orthodontic plan information according to one embodiment;

FIGS. 2 to 4 are exemplary diagrams illustrating a method of generating orthodontic plan information that is performed by an apparatus for generating orthodontic plan information according to one embodiment; and

FIGS. 5 to 7 are flowcharts illustrating a method of generating orthodontic plan information according to one embodiment.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is “directly connected” to the other component but also a case where the one component is “connected to the other component with a third component arranged therebetween.” Furthermore, when one portion is described as “including” one component, this does not mean that the portion does not exclude another component but means that the portion may further include another component, unless explicitly described to the contrary.

Embodiments will be described in detail below with reference to the accompanying drawings.

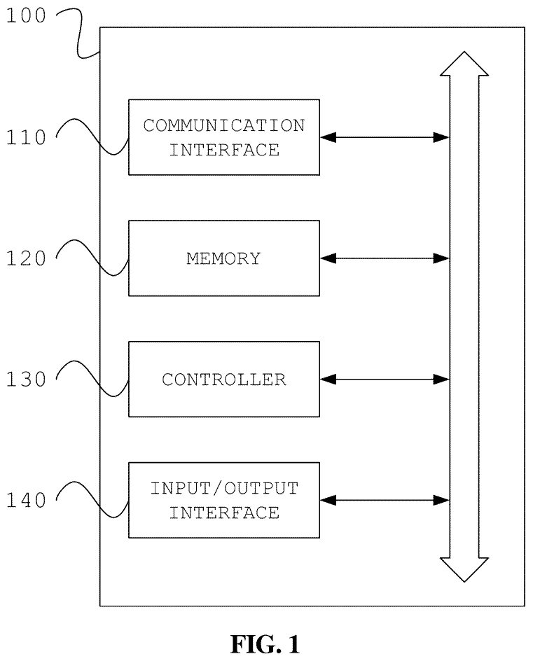

FIG. 1 is a block diagram showing the configuration of an apparatus 100 for generating orthodontic plan information according to one embodiment. The apparatus 100 for generating orthodontic plan information refers to an apparatus that generates a final orthodontic teeth model based on a patient's current teeth model received from a tooth scanning device and generates orthodontic plan information for the patient by using the final orthodontic teeth model.

Referring to FIG. 1, the apparatus 100 for generating orthodontic plan information according to the one embodiment may include a communication interface 110, memory 120, a controller 130, and an input/output interface 140.

The communication interface 110 may perform wired/wireless communication with another device or a network. To this end, the communication interface 110 may include a communication module configured to support at least one of various wired/wireless communication methods. For example, the communication module may be implemented in the form of a chipset.

The wireless communication supported by the communication interface 110 may be, for example, Wireless Fidelity (Wi-Fi), Wi-Fi Direct, Bluetooth, Ultra-Wide Band (UWB), or Near Field Communication (NFC). Furthermore, the wired communication supported by the communication interface 110 may be, for example, Universal Serial Bus (USB), or High Definition Multimedia Interface (HDMI). According to one embodiment, the communication interface 110 may communicate with a tooth scanning device (e.g., an oral scanner).

According to one embodiment, the communication interface 110 may obtain a current teeth model, modeling a patient's teeth state before orthodontic treatment, via a tooth scanning device by performing direct communication with the tooth scanning device or performing wired/wireless communication over a network. Alternatively, the communication interface 110 may obtain a current teeth model by requesting and receiving the current teeth model through wired/wireless communication with an external storage device where the current teeth model is stored.

Various types of data such as a file, an application, and a program may be installed and stored in the memory 120. The memory 120 may store a current teeth model that models a patient's teeth state before orthodontic treatment via a tooth scanning device. In this case, the “current teeth model” is 3D tooth data that is the result of an intraoral scan for a patient who wants to perform orthodontic treatment, and may include 3D data for the overall teeth including the maxillary teeth, the mandibular teeth, and the occlusal surfaces.

In addition, the memory 120 may store the orthodontic plan information generated by the controller 130 to be described below.

The controller 130 may control the overall operation of the apparatus 100 for generating orthodontic plan information, and may include one or more processors such as a CPU, GPU, or the like. When the controller 130 receives the patient's current teeth model through the communication interface 110, it may control other components included in the apparatus 100 for generating orthodontic plan information to perform a method of generating orthodontic plan information.

The controller 130 may generate an expanded teeth model by rearranging a plurality of teeth constituting the current teeth model so that predetermined spaces required for orthodontic treatment are secured. To this end, the controller 130 may identify the axes and feature points of all the teeth constituting the current teeth model.

More specifically, the controller 130 may identify and segment the individual teeth by identifying the contours of the teeth in the current teeth model. Furthermore, the controller 130 may identify the types of individual teeth, e.g., incisors, canines and molars, based on the shapes of the individual teeth and their adjacent teeth. For each of the identified teeth, the controller 130 may identify a Z axis corresponding to a direction perpendicular to the face, and extract an X axis corresponding to a direction parallel to the face and a Y axis parallel to the midline, which is a virtual line dividing the human body into left and right, based on the Z axis.

In addition, the controller 130 may identify the feature points of the individual teeth identified in the current teeth model. In this case, the “feature points” are points representing the positions of the individual teeth identified in the current teeth model, and may be used to align a teeth arrangement, to calculate occlusion, and to do the like. For example, the controller 130 may obtain the center points of the occlusal surfaces of the individual teeth constituting the current teeth model as feature points.

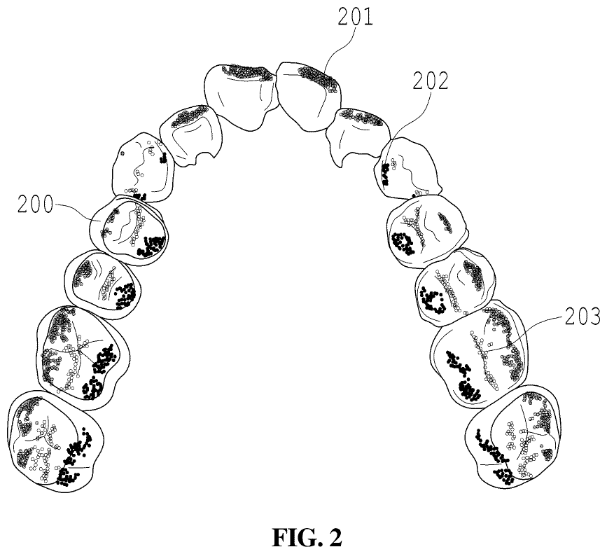

The controller 130 may obtain corrected axes information by correcting the axes of all the teeth that constitute the current teeth model. In this case, the “corrected axes information” refers to information about the axes corrected by taking into consideration the types and shapes of the teeth in order to accurately determine the postures of the teeth. In other words, the corrected axes information means information about how much each straight line connecting the apical foramen to the crown, i.e. each tooth direction, is rotated compared to the Y axis. For example, the corrected axes information includes angle information between the X-Y planes in each tooth direction and angle information between the Y-Z planes in each tooth direction. More specifically, the controller 130 may obtain corrected axes information by reflecting the shape features of incisors, canines, and molars therein, and may correct the axes of teeth based on the obtained corrected axes information. This will be described with reference to FIG. 2 later. FIG. 2 is an exemplary diagram illustrating a method by which an apparatus for generating orthodontic plan information according to one embodiment obtains corrected axes information from a current teeth model.

As shown in FIG. 2, the controller 130 may extract outer regions 201, inner regions 202, and depression regions 203 for a current teeth model 200. In this case, the “outer region” refers to a region corresponding to the labial and occlusal surfaces of each tooth. Furthermore, the “inner region” refers to a region corresponding to the lingual surface of each tooth. Moreover, the “depression region” refers to a region that is indented toward the gums among the irregularities of the occlusal surface of the tooth, i.e., the region that is the farthest from the occlusal surface.

For each of the incisors of the current teeth model 200, the controller 130 may obtain the normal vector of the outer region 201 and then obtain the corrected axes information in which a plurality of axes (an X axis, an Y axis, and a Z axis) for the incisor are corrected by taking into consideration the normal vector for the upper end of the incisor, i.e., the end region of the occlusal surface. Furthermore, for each of the canines of the current teeth model 200, the controller 130 may obtain the corrected axes information in which a plurality of axes (an X axis, an Y axis, and a Z axis) for the canine are corrected by taking into considering the normal vector of the outer region 201, which is the outer cylinder surface, and the normal vector of the depression region 203. Moreover, the controller 130 may obtain the corrected axes information in which a plurality of axes (an X axis, an Y axis, and a Z axis) for each of the molars by taking into consideration the normal vector of the depression area 203 for the molar and the normal vector of the outer area 201 of the molar.

Referring back to FIG. 1, the controller 130 may obtain the posture information of each of all the teeth constituting the current teeth model based on the corrected axes information. In this case, the “posture information” of the tooth refers to how much the tooth has rotated based on a specific axis with respect to the reference posture of the tooth. In this case, the reference posture may be set to the posture of an incisor, but is not limited thereto.

The controller 130 may calculate the angle difference cost between adjacent teeth for each of all the teeth constituting the current teeth model, and may optimize the postures of all the teeth constituting the current teeth model by taking into consideration the angle difference costs. In this case, the “angle difference cost” refers to an index corresponding to the angle difference of each of the X, Y, and Z axes for any tooth and one of its adjacent teeth.

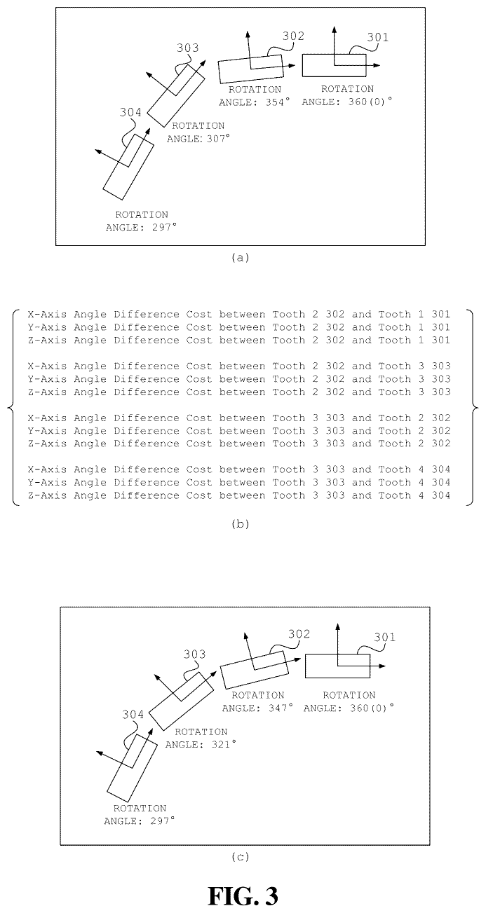

This will be described with reference to FIG. 3 later. FIG. 3 is an exemplary diagram illustrating a method by which an apparatus for generating orthodontic plan information according to an embodiment optimizes the postures of all the teeth constituting a current teeth model.

The controller 130 may obtain angle information for each of the X, Y, and Z axes based on the posture information of each of all the teeth constituting the current teeth model. In this case, the “angle information” refers to information about the rotation angle of each of the X, Y, and Z axes with respect to a reference posture.

Referring to FIG. 3(a), the controller 130 may obtain the angle information of the Z axis, 360°, based on the posture information of a first tooth 301. The controller 130 may obtain the angle information of the Z axis, 354°, for a second tooth 304, the angle information of the Z axis, 307°, for a third tooth 303, and the angle information of the Z axis, 297°, for a fourth tooth 304.

The controller 130 may calculate the angle difference cost between adjacent teeth for each axis based on the angle information. In order to smoothly connect the posture configuration from the first tooth 301 to the fourth tooth 304, the controller 130 may calculate angle difference costs for the second tooth 302 and the third tooth 303 while maintaining the angles for the first tooth 301 and the fourth tooth 304 corresponding to both ends. More specifically, the controller 130 may calculate the angle difference cost using Equation 1:

$$Angle Difference Cost = ( Angle Difference ) \times {w}_{distance} \times {w}_{shape} \qquad ( 1 )$$

where w_{distance} denotes a weight according to the distance between teeth and wₛₕₐₚₑ denotes a weight according to the shapes.

The controller 130 may define the X-axis angle difference cost, the Y-axis angle difference cost, and the Z-axis angle difference cost for each of all the teeth constituting the current teeth model as a residual matrix, and may generate a Jacobian matrix by partially differentiating the residual matrix in each axis direction.

More specifically, in the case of most teeth, two adjacent teeth are present based on one tooth. For example, as shown in FIG. 3(a), in the case where there are teeth 1, 2, 3 and 4 and teeth 1 and 4 are fixed teeth, when it is necessary to calculate the angle difference cost between teeth 2 and 3 for teeth 2 and 3, the controller 130 may generate a residual matrix such as that shown in FIG. 3(b) by calculating the X-axis angle difference cost between tooth 2 302 and tooth 1 301, the Y-axis angle difference cost between tooth 2 302 and tooth 1 301, the Z-axis angle difference cost between tooth 2 302 and tooth 1 301, the X-axis angle difference cost between tooth 2 302 and tooth 3 303, the Y-axis angle difference cost between tooth 2 302 and tooth 3 303, the Z-axis angle difference cost between tooth 2 302 and tooth 3 303, the X-axis angle difference cost between tooth 3 303 and tooth 2 302, the Y-axis angle difference cost between tooth 3 303 and tooth 2 302, the Z-axis angle difference cost between tooth 3 303 and tooth 2 302, the X-axis angle difference cost between tooth 3 303 and tooth 4 304, the Y-axis angle difference cost between tooth 3 303 and tooth 4 304, and the Z-axis angle difference cost between tooth 3 303 and tooth 4 304. The controller 130 may generate a Jacobian matrix by differentiating the residual matrix in each axis direction.

The controller 130 may obtain the angle, at which the sum of the angle difference costs is minimized, as an optimal angle by using the generated Jacobian matrix as a nonlinear optimization algorithm. In this case, the “nonlinear optimization algorithm” may be the Levenberg-Marquardt algorithm.

The controller 130 may calculate the optimal Z-axis angle of 347° for the second tooth 302 and the optimal Z-axis angle of 321° for the third tooth 303, excluding the first tooth 301 and the fourth tooth 304, as shown in FIG. 3(c). In this manner, the controller 130 may obtain the amounts of rotation, i.e., the amounts of angular movement, for the plurality of teeth constituting the current teeth model based on the calculated optimal angles.

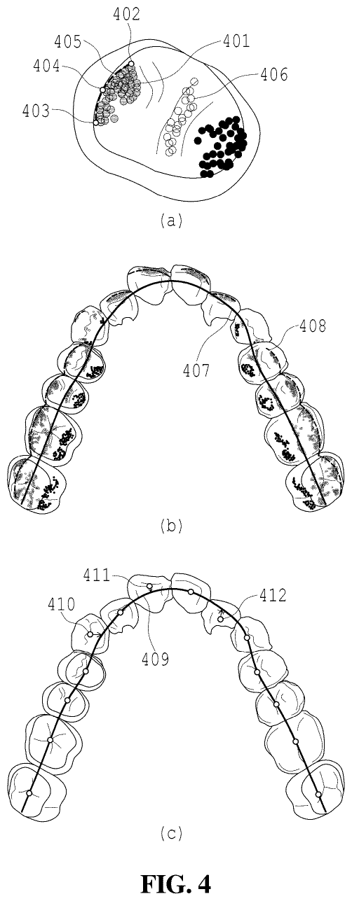

The controller 130 may define the arch functions of the maxillary teeth and mandibular teeth of the current teeth model in order to optimize a teeth arrangement based on the current teeth model. In this case, the “arch function” is a function for the distribution of teeth on an occlusal plane, which is a plane parallel to the occlusal surface of the current teeth model, and is represented in the form of a quadratic function. This will be described with reference to FIG. 4 later. FIG. 4 is an exemplary diagram illustrating a method by which an apparatus for generating orthodontic plan information according to one embodiment optimizes a teeth arrangement based on a current teeth model.

As shown in FIG. 4(a), the controller 130 may generate an outer arch 405 from an outer region 401 identified in each of the teeth constituting the current teeth model. More specifically, after both ends 402 and 403 and central portion 404 of the outer region 401 have been identified, an arch connecting the both ends 402 and 403 and the central portion 404 may be generated. Furthermore, the controller 130 may generate an arch connecting depression regions 406 identified in a plurality of teeth constituting the current teeth model.

More specifically, the controller 130 may generate an arch 407 connecting the depression regions, as shown in FIG. 4(b). Furthermore, the controller 130 may define the arch functions 409 of the maxillary teeth and the mandibular teeth based on a plurality of outer arches 408 extracted from the plurality of teeth constituting the current teeth model and the arch 407 connecting the depression regions, as shown in FIG. 4(c). That is, the controller 130 may calculate a two-dimensional curve, located between the arch 407 connecting the depression regions of the maxillary teeth of the current teeth model and the plurality of outer arches 408 for the plurality of teeth constituting the maxillary teeth of the current teeth model, as the arch function of the maxillary teeth of the current teeth model, and may also calculate a two-dimensional curve located between the arch 407 connecting the depression regions of the mandibular teeth of the current teeth model and the plurality of outer arches 408 for the plurality of teeth constituting the mandibular teeth of the current teeth model, as the arch function of the mandibular teeth of the current teeth model. More specifically, the controller 130 may define quadratic functions, similar to the distributions of the pluralities of outer arches extracted from the pluralities of teeth constituting the maxillary teeth and mandibular teeth of the current teeth model, as outer region arch functions, may define quadratic functions, similar to the arches connecting the depression regions, as depression region arch functions, and may define quadratic functions, corresponding to curves located between the curves represented by the outer region arch functions and the curves represented by the depression region arch functions, as the arch functions of the current teeth model.

According to another embodiment, in the case where a severely misaligned tooth, i.e., a protruding tooth, is identified when the controller 130 analyzes the current teeth model, the controller 130 may define an arch function by taking into consideration only teeth other than the protruding tooth. When defining the arch function, the controller 130 may prevent the distortion of the arch function attributable to the protruding tooth by not taking into consideration the protruding tooth.

The controller 130 may calculate the amounts of movement of all the tooth constituting the current teeth model by calculating the distance differences between the arrangement positions of the teeth constituting the maxillary teeth and mandibular teeth of the current teeth model and the arch functions. More specifically, as shown in FIG. 4(c), the controller 130 may identify teeth 410, 411, and 412 whose feature points are not located in the arch function 409 based on the feature points of individual teeth constituting the current teeth model, and may calculate the amounts of movement and the directions of movement that allow the identified teeth to be fitted to the arch function.

The controller 130 may rearrange the teeth constituting the current teeth model based on the calculated amounts of movement. The controller 130 may rearrange teeth constituting the current teeth model by moving any teeth constituting the current teeth model according to the calculated amounts of movement and the calculated directions of movement.

Thereafter, the controller 130 may analyze the rearranged teeth based on the current teeth model and adjust the heights of the rearranged teeth so that the height difference between the rearranged teeth and the adjacent teeth is equal to or smaller than a predetermined value, thereby generating an expanded teeth model. More specifically, the controller 130 may adjust the heights of the rearranged teeth. To this end, the controller 130 may define an occlusal plane from the current teeth model. In this case, the “occlusal plane” refers to a plane corresponding to the height at which the maxillary teeth and mandibular teeth of the current teeth model meet.

The controller 130 may compare the height value of an occlusal plane, i.e., an Y-axis value, which is the position value of the occlusal plane on a median plane, with the height value of the occlusal surface of each of the rearranged teeth, and may adjust the height of the rearranged tooth so that the height difference between the rearranged tooth and its adjacent tooth is equal to or smaller than a predetermined value. Furthermore, the controller 130 may adjust the height of the rearranged tooth so that the distance between the individual tooth and the opposing tooth that comes into contact with the individual tooth is minimized.

The controller 130 may determine whether there is an overlap region between adjacent teeth by analyzing the teeth model in which the heights of the rearranged teeth have been adjusted. When there is an overlap region, the controller 130 may generate an expanded teeth model by rearranging all the teeth constituting the current teeth model to secure a space corresponding to the overlap area. In this case, the controller 130 may take into consideration a plurality of options to secure the space. The “plurality of options” may be extraction, interproximal reduction (IPR), partial tooth fixation, space expansion direction fixation, etc. The controller 130 may generate a plurality of expanded teeth models according to the plurality of options. The controller 130 may calculate the total amount of movement of the teeth by comparing the expanded teeth model with the current teeth model. For example, the controller 130 may generate an expanded teeth model to secure a space corresponding to an overlap region based on a space caused by a tooth to be extracted in response to the extraction option. Furthermore, the controller 130 may generate an expanded teeth model so that a space corresponding to an overlap region is secured based on the cut space of an IPR target tooth in response to the IPR option.

The controller 130 may perform a collision error level test on the expanded teeth model. In this case, the “collision error level test” is a test intended to see whether the arrangement states of the teeth constituting the expanded teeth model satisfy preset conditions, and may include a plurality of conditions.

For example, the plurality of conditions may include a first condition in which the angle differences between the teeth constituting the expanded teeth model and their adjacent teeth are each a preset level or less, a second condition in which the positional differences on the occlusal plane are each a preset level or less when the arch functions defined from the current teeth model are compared with the arrangement positions of the teeth constituting the expanded teeth model, a third condition in which the differences between the median plane heights of the teeth constituting the expanded teeth model and the median plane height of the occlusal plane are each a preset level or less, and a fourth condition in which the calculated total amounts of movement of teeth are each a preset level or less.

More specifically, when the first condition in which the angle differences between the teeth constituting the expanded teeth model and their adjacent teeth are each a preset level or less, the second condition in which the positional differences on the occlusal plane are each a preset level or less when the arch functions defined from the current teeth model are compared with the arrangement positions of the teeth constituting the expanded teeth model, the third condition in which the differences between the median plane heights of the teeth constituting the expanded teeth model and the median plane height of the occlusal plane are each a preset level or less, and the fourth condition in which the calculated total amounts of movement of teeth are each a preset level or less are all satisfied, the controller 130 may determine the collision error level test to be successful.

According to another embodiment, when the expanded teeth model satisfies at least one of the first to fourth conditions, the controller 130 may determine the collision error level test to be passed and successful.

When the expanded teeth model does not satisfy at least one of the conditions included in the collision error level test, the controller 130 may determine the collision error level test for the expanded teeth model to fail and regenerate the expanded teeth model.

When the collision error level test for the expanded teeth model is successful, the controller 130 may generate a candidate orthodontic teeth model, in which the spaces between teeth constituting the expanded teeth model are filled, by rearranging the teeth through the spaces between the teeth constituting the expanded teeth model.

More specifically, the controller 130 may generate a corrected teeth model by adjusting the positions of all the teeth constituting the expanded teeth model based on the arch functions defined from the current teeth model and the calculated amounts of movement of the teeth.

The controller 130 may generate the candidate orthodontic teeth model by moving at least one of the maxillary teeth and mandibular teeth of the corrected teeth model so that the occlusal plane distances between the positions of the incisors of the maxillary teeth of the corrected teeth model and the positions of the incisors of the mandibular teeth of the corrected teeth model each fall within a predetermined range.

The controller 130 may perform a dental arch error level test on the candidate orthodontic teeth model. In this case, the “dental arch error level test” is a test intended to see whether the structure of the maxillary teeth and the mandibular teeth during the occlusion of the candidate orthodontic teeth model satisfies medical conditions, and includes a plurality of conditions.

For example, the plurality of conditions may include a fifth condition in which there is no space between the teeth constituting the candidate orthodontic teeth model, and a sixth condition in which the occlusal plane positions of the incisors of the maxillary teeth of the candidate orthodontic teeth model and the occlusal plane positions of the incisors of the mandibular teeth of the candidate orthodontic teeth model satisfy medical criteria according to a patient's teeth structure.

More specifically, when the candidate orthodontic teeth model satisfies all of the fifth condition in which there is no space between the teeth constituting the candidate orthodontic teeth model and the sixth condition in which the occlusal plane positions of the incisors of the maxillary teeth of the candidate orthodontic teeth model and the occlusal plane positions of the incisors of the mandibular teeth of the candidate orthodontic teeth model satisfy medical criteria according to the patient's teeth structure, the controller 130 may determine the dental arch error level test to be successful. Furthermore, when the candidate orthodontic teeth model does not satisfy at least one of the plurality of conditions included in the dental arch error level test, the controller 130 may determine the dental arch error level test for the candidate orthodontic teeth model to fail and regenerate the candidate orthodontic teeth model.

According to another embodiment, when the candidate orthodontic teeth model satisfies at least one of the fifth and sixth conditions, the controller 130 may determine the dental arch error level test to be passed and be successful.

When the dental arch error level test for the candidate orthodontic teeth model is successful, the controller 130 may confirm the candidate orthodontic teeth model as a final orthodontic teeth model and generate orthodontic plan information based on the final orthodontic teeth model. In this case, the “orthodontic plan information” may include information about the final orthodontic teeth model, a subsequent orthodontic plan scheduled date, and information about an option corresponding to the final orthodontic teeth model out of the options considered to secure space. In this case, the “subsequent orthodontic plan scheduled date” refers to a date corresponding to the time expected for the teeth to move and reach the positions of the final orthodontic teeth model based on the current teeth model and the final orthodontic teeth model.

More specifically, the controller 130 may generate a design drawing required for manufacturing an orthodontic device based on the final orthodontic teeth model. The controller 130 may generate a design drawing and orthodontic plan information including the current teeth model and the final orthodontic teeth model. Through this configuration, when the intraoral scan of a patient is completed during an orthodontic treatment process, a corresponding orthodontic teeth model may be acquired, so that per-step orthodontic devices can be generated according to the patient's current teeth condition.

Meanwhile, the controller 130 may determine a plurality of options by taking into consideration the states of the teeth constituting the current teeth model, and may generate a plurality of candidate orthodontic teeth models corresponding to the plurality of options based on expanded teeth models generated according to the plurality of options. The controller 130 may provide candidate orthodontic teeth models corresponding to the plurality of options through the input/output interface 140 to be described below, and may determine a candidate orthodontic teeth model, selected by a user (a patient or an orthodontist) from among the plurality of candidate orthodontic teeth models, as a final orthodontic teeth model.

The input/output interface 140 may include an input interface for receiving input from a user, such as a patient or an orthodontist, and an output interface for displaying information, such as the result of performing a task or the status of the apparatus 100 for generating orthodontic plan information. For example, the input/output interface 140 may include an operation panel for receiving user inputs and a display panel for displaying screens.

More specifically, the input interface may include devices capable of receiving various forms of user input, such as a keyboard, a physical button, a touch screen, a camera, and a microphone. Furthermore, the output interface may include a display panel, a speaker, and/or the like. However, the input/output interface 140 is not limited thereto, and may include components for supporting various types of input/output.

The input/output interface 140 may output the orthodontic plan information generated by the controller 130. More specifically, the input/output interface 140 may display a current teeth model, a final orthodontic teeth model, and per-step orthodontic teeth models. To this end, the controller 130 may predict the expected amounts of movement of teeth by taking into consideration the amounts of movement of the teeth and the amounts angular movement of the teeth between the final orthodontic teeth model and the current teeth model, and may generate per-step orthodontic teeth models that move by the expected amounts of movement of the teeth up to a specific time, e.g., a subsequent scheduled intraoral scan date.

As a result, the controller 130 may generate orthodontic teeth models required for generating per-step orthodontic devices that can comply with the medical allowances that allow a patient's teeth to move maximally during a preset period.

According to another embodiment, the input/output interface 140 may display a plurality of candidate orthodontic teeth models corresponding to a plurality of options. The input/output interface 140 may include a user interface for receiving an option selected by a user.

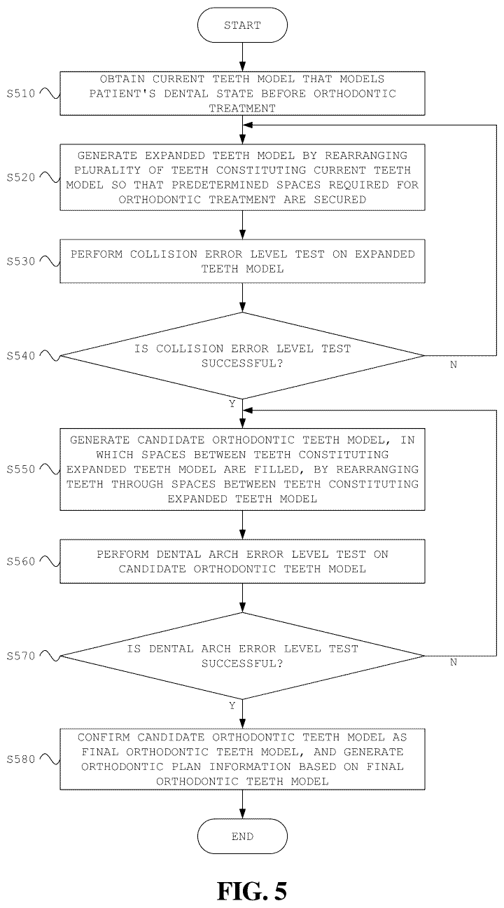

FIGS. 5 to 7 are flowcharts illustrating a method of generating orthodontic plan information according to one embodiment.

The method of generating orthodontic plan information according to the embodiment shown in FIGS. 5 to 7 includes the steps that are processed in a time-series manner by the apparatus 100 for generating orthodontic plan information shown in FIGS. 1 to 4. Accordingly, the descriptions that are omitted below but have been given above in conjunction with the apparatus 100 for generating orthodontic plan information shown in FIGS. 1 to 4 may also be applied to the method of generating orthodontic plan information according to the embodiment shown in FIGS. 5 to 7.

Referring to FIG. 5, the apparatus 100 for generating orthodontic plan information may obtain a current teeth model that models a patient's teeth state before orthodontic treatment in step S510. For example, the apparatus 100 for generating orthodontic plan information may obtain a current teeth model, modeling a patient's teeth state before orthodontic treatment, by performing wired/wireless communication with a tooth scanning device. Alternatively, the apparatus 100 for generating orthodontic plan information may obtain a current teeth model by performing wired/wireless communication with an external device in which the current teeth model is stored. The apparatus 100 for generating orthodontic plan information may generate an expanded teeth model by rearranging a plurality of teeth constituting the current teeth model so that predetermined spaces required for orthodontic treatment are secured in step S520.

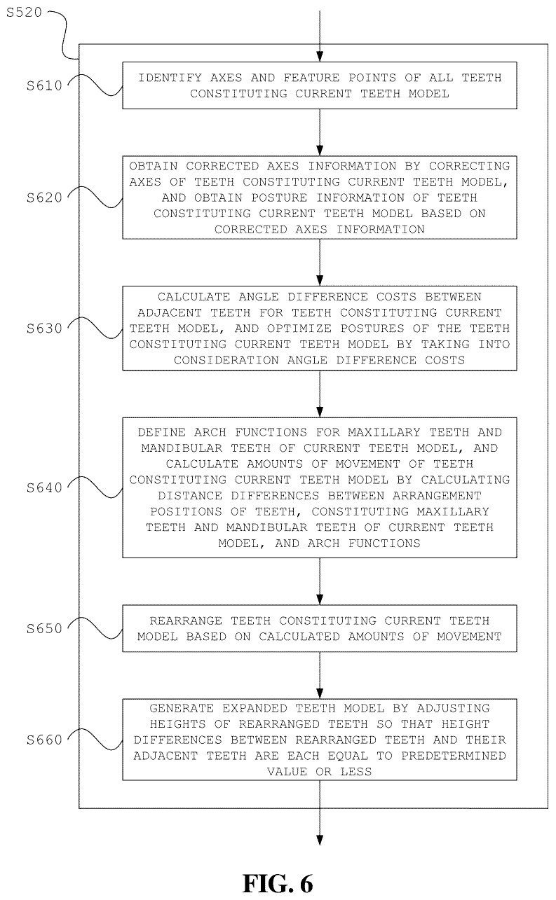

Step S520 will be described in more detail with reference to FIG. 6 below. FIG. 6 is a flowchart illustrating a method of generating an expanded teeth model according to an embodiment in the method of generating orthodontic plan information.

Referring to FIG. 6, the apparatus 100 for generating orthodontic plan information may identify the axes and feature points of all teeth constituting the current teeth model. More specifically, the apparatus 100 for generating orthodontic plan information may identify and segment the individual teeth by identifying the contours of the teeth in the current teeth model. Furthermore, the apparatus 100 for generating orthodontic plan information may identify the types of individual teeth, e.g., incisors, canines and molars, based on the shapes of the individual teeth and their adjacent teeth. For each of the identified teeth, the apparatus 100 for generating orthodontic plan information may identify a Z axis corresponding to a direction perpendicular to the face, and extract an X axis corresponding to a direction parallel to the face and a Y axis parallel to the midline, which is a virtual line dividing the human body into left and right, based on the Z axis. In addition, the apparatus 100 for generating orthodontic plan information may identify the feature points of the individual teeth identified in the current teeth model.

The apparatus 100 for generating orthodontic plan information may obtain corrected axes information by correcting the axis of each of the teeth constituting the current teeth model and may also obtain the posture information of each of the teeth constituting the current teeth model based on the corrected axes information in step S620. More specifically, the apparatus 100 for generating orthodontic plan information may obtain corrected axes information by reflecting the shape features of incisors, canines, and molars therein, and may correct the axes of teeth based on the obtained corrected axes information.

The apparatus 100 for generating orthodontic plan information may calculate the angle difference cost between adjacent teeth for each of all the teeth constituting the current teeth model, and may optimize the postures of all the teeth constituting the current teeth model by taking into consideration the angle difference costs in step S630. More specifically, the apparatus 100 for generating orthodontic plan information may calculate the angle difference cost using Equation 1 described above.

The apparatus 100 for generating orthodontic plan information may define the X-axis angle difference cost, the Y-axis angle difference cost, and the Z-axis angle difference cost for each of all the teeth constituting the current teeth model as a residual matrix, and may generate a Jacobian matrix by partially differentiating the residual matrix in each axis direction. The apparatus 100 for generating orthodontic plan information may obtain the angle, at which the sum of the angle difference costs is minimized, as an optimal angle by using the generated Jacobian matrix as a nonlinear optimization algorithm. In this case, the “nonlinear optimization algorithm” may be the Levenberg-Marquardt algorithm. The apparatus 100 for generating orthodontic plan information may obtain the amounts of rotation, i.e., the amounts of angular movement, for the plurality of teeth constituting the current teeth model based on the calculated optimal angles.

The apparatus 100 for generating orthodontic plan information may define arch functions for the maxillary teeth and mandibular teeth of the current teeth model and may calculate the amounts of movement of the teeth constituting the current teeth model by calculating the distance differences between the arrangement positions of the teeth constituting each of the maxillary teeth and mandibular teeth of the current teeth model and the arch functions in step S640. More specifically, the apparatus 100 for generating orthodontic plan information may generate an outer arch from an outer region identified in each of the teeth constituting the current teeth model. Furthermore, the apparatus 100 for generating orthodontic plan information may generate an arch connecting depression regions identified in the plurality of teeth constituting the current teeth model. Furthermore, the apparatus 100 for generating orthodontic plan information may define the arch functions of the maxillary teeth and the mandibular teeth based on a plurality of outer arches extracted from the plurality of teeth constituting the current teeth model and the arch connecting the depression regions. More specifically, the apparatus 100 for generating orthodontic plan information may define quadratic functions, similar to the distributions of the pluralities of outer arches extracted from the pluralities of teeth constituting the maxillary teeth and mandibular teeth of the current teeth model, as outer region arch functions, may define quadratic functions, similar to the arches connecting the depression regions, as depression region arch functions, and may define quadratic functions, corresponding to curves located between the curves represented by the outer region arch functions and the curves represented by the depression region arch functions, as the arch functions of the current teeth model.

According to another embodiment, in the case where a severely misaligned tooth, i.e., a protruding tooth, is identified when the controller 130 analyzes the current teeth model, the apparatus 100 for generating orthodontic plan information may define an arch function by taking into consideration only teeth other than the protruding tooth. When defining the arch function, the apparatus 100 for generating orthodontic plan information may prevent the distortion of the arch function attributable to the protruding tooth by not taking into consideration the protruding tooth.

The apparatus 100 for generating orthodontic plan information may rearrange the teeth constituting the current teeth model based on the calculated amounts of movement in step S650. Thereafter, the apparatus 100 for generating orthodontic plan information may generate an expanded teeth model by adjusting the heights of the rearranged teeth so that the height difference between the rearranged teeth and the adjacent teeth is equal to or smaller than a predetermined value in step S660. To this end, the apparatus 100 for generating orthodontic plan information may define an occlusal plane from the current teeth model. The apparatus 100 for generating orthodontic plan information may compare the height value of an occlusal plane, i.e., an Y-axis value, which is the position value of the occlusal plane on a median plane, with the height value of the occlusal surface of each of the rearranged teeth, and may adjust the height of the rearranged tooth so that the height difference between the rearranged tooth and its adjacent tooth is equal to or smaller than a predetermined value.

The apparatus 100 for generating orthodontic plan information may determine whether there is an overlap region between adjacent teeth by analyzing the teeth model in which the heights of the rearranged teeth have been adjusted. The apparatus 100 for generating orthodontic plan information may generate an expanded teeth model by rearranging all the teeth constituting the current teeth model to secure a space corresponding to the overlap area. In this case, the apparatus 100 for generating orthodontic plan information may take into consideration a plurality of options to secure the space. The “plurality of options” may be extraction, interproximal reduction (IPR), partial tooth fixation, space expansion direction fixation, etc. The apparatus 100 for generating orthodontic plan information may generate a plurality of expanded teeth models according to the plurality of options. The apparatus 100 for generating orthodontic plan information may calculate the total amount of movement of the teeth by comparing the expanded teeth model with the current teeth model.

Referring again to FIG. 5, the apparatus 100 for generating orthodontic plan information may perform a collision error level test on the expanded teeth model in step S530. The apparatus 100 for generating orthodontic plan information may determine whether the collision error level test on the expanded teeth model is successful or not in step S540.

More specifically, when the first condition in which the angle differences between the teeth constituting the expanded teeth model and their adjacent teeth are each a preset level or less, the second condition in which the positional differences on the occlusal plane are each a preset level or less when the arch functions defined from the current teeth model are compared with the arrangement positions of the teeth constituting the expanded teeth model, the third condition in which the differences between the median plane heights of the teeth constituting the expanded teeth model and the median plane height of the occlusal plane are each a preset level or less, and the fourth condition in which the calculated total amounts of movement of teeth are each a preset level or less are all satisfied, the apparatus 100 for generating orthodontic plan information may determine the collision error level test to be successful.

According to another embodiment, when the expanded teeth model satisfies at least one of the first to fourth conditions, the apparatus 100 for generating orthodontic plan information may determine the collision error level test to be passed and successful.

When the expanded teeth model does not satisfy at least one of the conditions included in the collision error level test, the apparatus 100 for generating orthodontic plan information may determine the collision error level test for the expanded teeth model to fail and regenerate the expanded teeth model. That is, step S520 may be performed again.

When the collision error level test for the expanded teeth model is successful, the controller 130 may generate a candidate orthodontic teeth model, in which the spaces between teeth constituting the expanded teeth model are filled, by rearranging the teeth through the spaces between the teeth constituting the expanded teeth model in step S550.

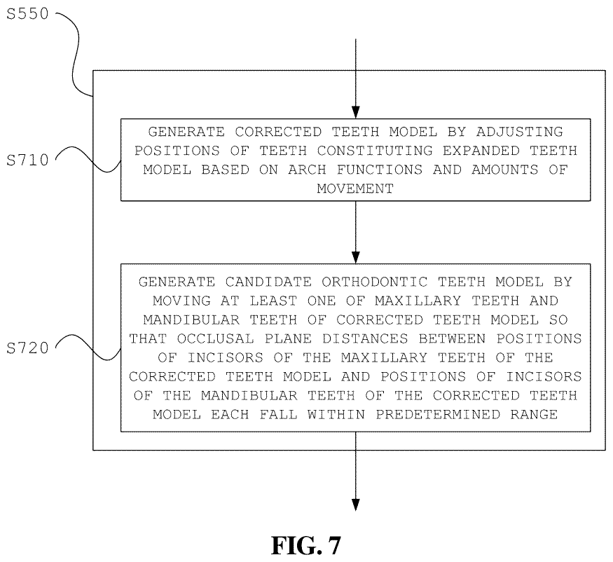

Step S550 will be described with reference to FIG. 7 below. FIG. 7 is a flowchart illustrating a method of generating a candidate orthodontic teeth model in the method of generating orthodontic plan information according to an embodiment.

Referring to FIG. 7, the apparatus 100 for generating orthodontic plan information may generate a corrected teeth model by adjusting the positions of all the teeth constituting the expanded teeth model based on the arch functions defined from the current teeth model and the calculated amounts of movement of the teeth in step S710.

The apparatus 100 for generating orthodontic plan information may generate the candidate orthodontic teeth model by moving at least one of the maxillary teeth and mandibular teeth of the corrected teeth model so that the occlusal plane distances between the positions of the incisors of the maxillary teeth of the corrected teeth model and the positions of the incisors of the mandibular teeth of the corrected teeth model each fall within a predetermined range in step S720.

Referring again to FIG. 5, the apparatus 100 for generating orthodontic plan information may perform a dental arch error level test on the candidate orthodontic teeth model in step S560. The apparatus 100 for generating orthodontic plan information may determine whether the dental arch error level test on the candidate orthodontic teeth model is successful or not in step S570.

More specifically, when the candidate orthodontic teeth model satisfies all of the fifth condition in which there is no space between the teeth constituting the candidate orthodontic teeth model and the sixth condition in which the occlusal plane positions of the incisors of the maxillary teeth of the candidate orthodontic teeth model and the occlusal plane positions of the incisors of the mandibular teeth of the candidate orthodontic teeth model satisfy medical criteria according to a patient's teeth structure, the apparatus 100 for generating orthodontic plan information may determine the dental arch error level test to be successful.

According to another embodiment, when the candidate orthodontic teeth model satisfies at least one of the fifth and sixth conditions, the apparatus 100 for generating orthodontic plan information may determine the dental arch error level test to be passed and be successful.

When the candidate orthodontic teeth model does not satisfy at least one of the plurality of conditions included in the dental arch error level test, the apparatus 100 for generating orthodontic plan information may determine the dental arch error level test for the candidate orthodontic teeth model to fail and regenerate the candidate orthodontic teeth model. That is, step S550 may be performed again.

When the dental arch error level test for the candidate orthodontic teeth model is successful, the apparatus 100 for generating orthodontic plan information may confirm the candidate orthodontic teeth model as a final orthodontic teeth model and generate orthodontic plan information based on the final orthodontic teeth model in step S580. More specifically, the apparatus 100 for generating orthodontic plan information may generate a design drawing required for manufacturing an orthodontic device based on the final orthodontic teeth model. The apparatus 100 for generating orthodontic plan information may generate a design drawing and orthodontic plan information including the current teeth model and the final orthodontic teeth model. The apparatus 100 for generating orthodontic plan information may display the generated orthodontic plan information to the patient.

Through this configuration, when the intraoral scan of a patient is completed during an orthodontic treatment process, a corresponding orthodontic teeth model may be acquired, so that per-step orthodontic devices can be generated according to the patient's current teeth condition.

According to another embodiment, the apparatus 100 for generating orthodontic plan information may determine a plurality of options by taking into consideration the states of the teeth constituting the current teeth model, and may generate a plurality of expanded teeth models corresponding to the plurality of options. The apparatus 100 for generating orthodontic plan information may generate a plurality of candidate orthodontic teeth models based on expanded teeth models corresponding to the plurality of options. The apparatus 100 for generating orthodontic plan information may display the plurality of candidate orthodontic teeth models to the patient. For example, the apparatus 100 for generating orthodontic plan information may generate an expanded teeth model to secure a space corresponding to an overlap region based on a space caused by a tooth to be extracted in response to the extraction option. Furthermore, the apparatus 100 for generating orthodontic plan information may generate an expanded teeth model so that a space corresponding to an overlap region is secured based on the cut space of an IPR target tooth in response to the IPR option. Meanwhile, the apparatus 100 for generating orthodontic plan information may provide candidate orthodontic teeth models corresponding to the plurality of options, and may determine a candidate orthodontic teeth model, selected by a user (a patient or an orthodontist) from among the plurality of candidate orthodontic teeth models, as a final orthodontic teeth model.

According to another embodiment, the apparatus 100 for generating orthodontic plan information may predict the expected amounts of movement of teeth by taking into consideration the amounts of movement of the teeth and the amounts angular movement of the teeth between the final orthodontic teeth model and the current teeth model, and may generate per-step orthodontic teeth models that move by the expected amounts of movement of the teeth up to a specific time, e.g., a subsequent scheduled intraoral scan date. As a result, the apparatus 100 for generating orthodontic plan information may generate orthodontic teeth models required for generating per-step orthodontic devices that can comply with the medical allowances that allow the patient's teeth to move maximally during a preset period.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

Components and a function provided in “unit(s)” may be coupled to a smaller number of components and “unit(s)” or divided into a larger number of components and “unit(s).”

In addition, components and “unit(s)” may be implemented to run one or more central processing units (CPUs) in a device or secure multimedia card.

Thee method of generating orthodontic plan information according to the embodiment described in conjunction with FIGS. 5 to 7 may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the method of generating orthodontic plan information according to the embodiment described in conjunction with FIGS. 5 to 7 may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the method of generating orthodontic plan information according to the embodiment described in conjunction with FIGS. 5 to 7 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. An apparatus for generating orthodontic plan information that performs a method of generating orthodontic plan information based on a current dental state of a patient who intends to receive orthodontic treatment, the apparatus comprising:
memory configured to store a current teeth model that models a patient's dental state before orthodontic treatment; and
a controller configured to generate an expanded teeth model by rearranging a plurality of teeth constituting the current teeth model so that predetermined spaces required for orthodontic treatment are secured, to perform a collision error level test on the expanded teeth model, to, when the collision error level test for the expanded teeth model is successful, generate a candidate orthodontic teeth model, in which spaces between teeth constituting the expanded teeth model are filled, by rearranging the teeth through the spaces between the teeth constituting the expanded teeth model, to perform a dental arch error level test on the candidate orthodontic teeth model, and to, when the dental arch error level test for the candidate orthodontic teeth model is successful, confirm the candidate orthodontic teeth model as a final orthodontic teeth model and generate orthodontic plan information based on the final orthodontic teeth model.

2. The apparatus of claim 1, wherein the controller:
identifies axes and feature points of all the teeth constituting the current teeth model;
obtains corrected axes information by correcting the axes of the teeth constituting the current teeth model, and obtains posture information of the teeth constituting the current teeth model based on the corrected axes information;
calculates angle difference costs between adjacent teeth for the teeth constituting the current teeth model, and optimizes postures of the teeth constituting the current teeth model by taking into consideration the angle difference costs;
defines arch functions for maxillary teeth and mandibular teeth of the current teeth model, and calculates amounts of movement of the teeth constituting the current teeth model by calculating distance differences between arrangement positions of the teeth, constituting the maxillary teeth and mandibular teeth of the current teeth model, and the arch functions;
rearranges the teeth constituting the current teeth model based on the calculated amounts of movement; and
generates the expanded teeth model by adjusting heights of the rearranged teeth so that height differences between the rearranged teeth and their adjacent teeth are each equal to a predetermined value or less.

3. The apparatus of claim 2, wherein the controller:
when the expanded teeth model satisfies all of a first condition in which angle differences between the teeth constituting the expanded teeth model and their adjacent teeth are each a preset level or less, a second condition in which positional differences on an occlusal plane are each a preset level or less when the arch functions defined from the current teeth model are compared with arrangement positions of the teeth constituting the expanded teeth model, a third condition in which differences between median plane heights of the teeth constituting the expanded teeth model and a median plane height of the occlusal plane are each a preset level or less, and a fourth condition in which calculated total amounts of movement of teeth are each a preset level or less, determines the collision error level test to be successful; and
when the expanded teeth model does not satisfy at least one of the conditions included in the collision error level test, determines the collision error level test for the expanded teeth model to fail and regenerates the expanded teeth model.

4. The apparatus of claim 2, wherein the controller:
generates a corrected teeth model by adjusting the positions of the teeth constituting the expanded teeth model based on the arch functions and the amounts of movement; and
generates the candidate orthodontic teeth model by moving at least one of maxillary teeth and mandibular teeth of the corrected teeth model so that occlusal plane distances between positions of incisors of the maxillary teeth of the corrected teeth model and positions of incisors of the mandibular teeth of the corrected teeth model each fall within a predetermined range.

5. The apparatus of claim 1, wherein the controller:
when the candidate orthodontic teeth model satisfies all of a fifth condition in which there is no space between the teeth constituting the candidate orthodontic teeth model and a sixth condition in which occlusal plane positions of incisors of maxillary teeth of the candidate orthodontic teeth model and occlusal plane positions of incisors of mandibular teeth of the candidate orthodontic teeth model satisfy medical criteria according to the patient's teeth structure, determines the dental arch error level test to be successful; and
when the candidate orthodontic teeth model does not satisfy at least one of the plurality of conditions included in the dental arch error level test, determines the dental arch error level test for the candidate orthodontic teeth model to fail, and regenerates the candidate orthodontic teeth model.

6. The apparatus of claim 1, wherein:
the controller determines a plurality of options by taking into consideration a state of the teeth constituting the current teeth model, generates expanded teeth models for the plurality of respective options, and generates a plurality of candidate orthodontic teeth models based on the expanded teeth models for the plurality of respective options; and
the apparatus further comprises an input/output interfaced configured to display the plurality of candidate orthodontic teeth models.

7. A method of generating orthodontic plan information, the method generating orthodontic plan information based on a current dental state of a patient who intends to receive orthodontic treatment and being performed by an apparatus for generating orthodontic plan information, the method comprising:
obtaining a current teeth model that models a patient's dental state before orthodontic treatment;
generating an expanded teeth model by rearranging a plurality of teeth constituting the current teeth model so that predetermined spaces required for orthodontic treatment are secured;
performing a collision error level test on the expanded teeth model;
when the collision error level test for the expanded teeth model is successful, generating a candidate orthodontic teeth model, in which spaces between teeth constituting the expanded teeth model are filled, by rearranging the teeth through the spaces between the teeth constituting the expanded teeth model;
performing a dental arch error level test on the candidate orthodontic teeth model; and
when the dental arch error level test for the candidate orthodontic teeth model is successful, confirming the candidate orthodontic teeth model as a final orthodontic teeth model, and generating orthodontic plan information based on the final orthodontic teeth model.

8. The method of claim 7, wherein generating the expanded teeth model comprises:
identifying axes and feature points of all the teeth constituting the current teeth model;
obtaining corrected axes information by correcting the axes of the teeth constituting the current teeth model, and obtaining posture information of the teeth constituting the current teeth model based on the corrected axes information;
calculating angle difference costs between adjacent teeth for the teeth constituting the current teeth model, and optimizing postures of the teeth constituting the current teeth model by taking into consideration the angle difference costs;
defining arch functions for maxillary teeth and mandibular teeth of the current teeth model, and calculating amounts of movement of the teeth constituting the current teeth model by calculating distance differences between arrangement positions of the teeth, constituting the maxillary teeth and mandibular teeth of the current teeth model, and the arch functions;
rearranging the teeth constituting the current teeth model based on the calculated amounts of movement; and
generating the expanded teeth model by adjusting heights of the rearranged teeth so that height differences between the rearranged teeth and their adjacent teeth are each equal to a predetermined value or less.

9. The method of claim 8, wherein:
performing the collision error level test on the expanded teeth model comprises, when the expanded teeth model satisfies all of a first condition in which angle differences between the teeth constituting the expanded teeth model and their adjacent teeth are each a preset level or less, a second condition in which positional differences on an occlusal plane are each a preset level or less when the arch functions defined from the current teeth model are compared with arrangement positions of the teeth constituting the expanded teeth model, a third condition in which differences between median plane heights of the teeth constituting the expanded teeth model and a median plane height of the occlusal plane are each a preset level or less, and a fourth condition in which calculated total amounts of movement of teeth are each a preset level or less, determining the collision error level test to be successful; and
the method further comprises, when the expanded teeth model does not satisfy at least one of the conditions included in the collision error level test, determining the collision error level test for the expanded teeth model to fail and regenerating the expanded teeth model.

10. The method of claim 8, wherein generating the candidate orthodontic teeth model comprises:
generating a corrected teeth model by adjusting positions of the teeth constituting the expanded teeth model based on the arch functions and the amounts of movement; and
generating the candidate orthodontic teeth model by moving at least one of maxillary teeth and mandibular teeth of the corrected teeth model so that occlusal plane distances between positions of incisors of the maxillary teeth of the corrected teeth model and positions of incisors of the mandibular teeth of the corrected teeth model each fall within a predetermined range.

11. The method of claim 10, wherein:
performing the dental arch error level test for the candidate orthodontic teeth model comprises, when the candidate orthodontic teeth model satisfies all of a fifth condition in which there is no space between the teeth constituting the candidate orthodontic teeth model and a sixth condition in which occlusal plane positions of incisors of maxillary teeth of the candidate orthodontic teeth model and occlusal plane positions of incisors of mandibular teeth of the candidate orthodontic teeth model satisfy medical criteria according to the patient's teeth structure, determining the dental arch error level test to be successful; and
the method further comprises, when the candidate orthodontic teeth model does not satisfy at least one of the plurality of conditions included in the dental arch error level test, determining the dental arch error level test for the candidate orthodontic teeth model to fail, and regenerating the candidate orthodontic teeth model.

12. The method of claim 7, further comprising:
determining a plurality of options by taking into consideration a state of the teeth constituting the current teeth model, and generating expanded teeth models for the plurality of respective options;
generating a plurality of candidate orthodontic teeth models based on the expanded teeth models for the plurality of respective options; and
displaying the plurality of candidate orthodontic teeth models.

13. A non-transitory computer-readable storage medium having stored thereon a program that, when executed by a processor, causes the processor to execute the method set forth in claim 7.

14. A computer program that is executed by an apparatus for generating orthodontic plan information and stored in a non-transitory computer-readable storage medium to perform the method set forth in claim 7.
